(19) United States
(12) Patent Application Publication
(10) Pub. No.: US 2026/0214475 A1
(43) Pub. Date: Jul. 23, 2026

(54) BACKHAUL LINK MANAGEMENT, APPARATUS, AND COMPUTER-READABLE MEDIUM

(71) Applicant: ZTE CORPORATION, Shenzhen, Guangdong (CN)

(72) Inventors: Jianxun AI, Shenzhen (CN); Jing LIU, Shenzhen (CN); Ziyang LI, Shenzhen (CN); Nan ZHANG, Shenzhen (CN)

(21) Appl. No.: 19/144,162

(22) PCT Filed: Feb. 16, 2023
(86) PCT No.: PCT/CN2023/076556

§ 371 Date: Jun. 27, 2025

(51) Int. Cl. H04W 24/04; H04W 24/02; H04W 24/08; H04W 72/231; H04W 84/04

(52) U.S. Cl. CPC H04W 24/04; H04W 24/02; H04W 24/08; H04W 72/231; H04W 84/047

(57) ABSTRACT

Wireless communication methods are disclosed. A wireless communication method includes establishing one or more backhaul links between a wireless communication node and a base station (BS); and receiving, by the wireless communication node, first configuration information for performing radio link monitoring (RLM) or beam failure detection (BFD) for the one or more backhaul links.

### TECHNICAL FIELD

This disclosure is generally related to wireless communication, and more particularly wireless communication regarding a backhaul link.

### BACKGROUND

Wireless communication technologies are pivotal components of the increasingly interconnecting global communication networks. Wireless communications rely on accurately allocated time and frequency resources for transmitting and receiving wireless signals. A repeater can increase the coverage of the wireless communication signal, but how to manage the backhaul link of the repeater can be improved.

### SUMMARY

This summary is a brief description of certain aspects of this disclosure. It is not intended to limit the scope of this disclosure.

According to some embodiments of this disclosure, a wireless communication method is provided. The method includes establishing one or more backhaul links between a wireless communication node and a base station (BS); and receiving, by the wireless communication node, first configuration information for performing radio link monitoring (RLM) or beam failure detection (BFD) for the one or more backhaul links.

According to some embodiments of this disclosure, another wireless communication method is provided. The method includes establishing one or more backhaul links between a wireless communication node and a base station (BS); and sending, by the BS, first configuration information for the wireless communication node to perform radio link monitoring (RLM) or beam failure detection (BFD) for the one or more backhaul links.

Still another embodiment of this disclosure provides a wireless communication apparatus, including a memory storing one or more programs and a processor electrically coupled to the memory and configured to execute the one or more programs to perform any method or step or their combination in this disclosure.

Still another embodiment of this disclosure provides non-transitory computer-readable storage medium, storing one or more programs, the one or more program being configured to, when performed by a processor, cause to perform any method or step or their combination in this disclosure.

According to some embodiments of this disclosure, one or more wireless communication methods are further disclosed, the methods include combinations of certain methods, aspects, elements, and steps (either in a generic view or specific view) disclosed in the various embodiments of this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system with a repeater;

FIG. 2 shows a component structure of different wireless communication nodes of FIG. 1; and

FIG. 3 shows a frequency resource assignment according to some examples of this disclosure.

### DETAILED DESCRIPTION

Communication coverage is one of focus aspects of cellular network deployments. Mobile operators rely on different types of network nodes to offer blanket coverage in their deployments. As a result, new types of network nodes have been considered in order to increase mobile operators' flexibility for their network deployments. For example, Integrated Access and Backhaul (IAB) was introduced and further enhanced to serve as a new type of network nodes, which does not require a wired backhaul. Another type of network node is the RF (Radio Frequency) repeater, which simply amplifies and forwards received signals. The RF repeaters have seen a wide range of deployments to supplement the coverage provided by regular full-stack cells.

A network-controlled repeater was also introduced as an enhancement over conventional RF repeaters with a capability to receive and process lateral control information from the network. Lateral control information may allow a network-controlled repeater to perform an amplify-and-forward operation in a more efficient manner. Potential benefits could include mitigation of unnecessary noise amplification, transmissions and receptions with better spatial directivity, and simplified network integration. Therefore, network-controlled repeaters are viewed by some industry players as a stepping stone of a re-configurable intelligent surface (RIS). An RIS node can adjust the phase and amplitude of received signal to improve the coverage.

This disclosure generally relates to, among other things, such kind of network nodes (or smart nodes (SN)), including, but not limited to, network-controlled repeaters (NCR), smart repeaters, RIS, or IAB.

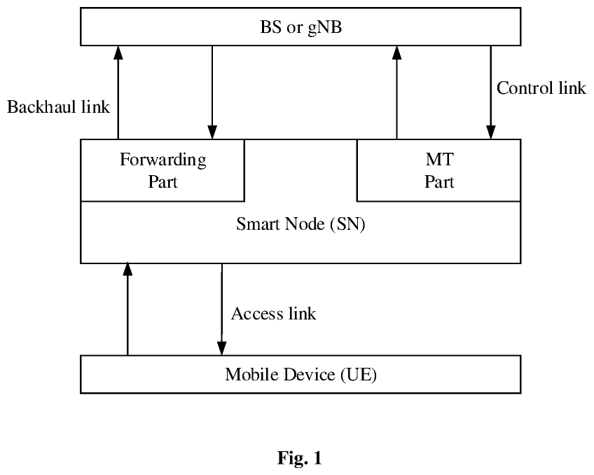

FIG. 1 illustrates an exemplary model of a wireless communication system with an intermediate SN. The SN may include into two parts, the mobile termination (MT) part and the forwarding part. The radio link between the base station (BS) and the forwarding part includes a backhaul link, and the radio link between the BS and the MT part includes a control link. The radio link between the SN and the mobile device, or UE, includes an access link. In the downlink transmission of the backhaul link, the forwarding part forwards the radio signals received from the BS and forwards to mobile device. In the uplink transmission of the backhaul link, the forwarding part forwards the radio signals received from the mobile device and forwards to the BS. The forwarding part may process the radio signals or only amplify the radio signals. The MT part may be connected to the BS as a normal mobile device. In addition, the MT part may receive side control information (forwarding configuration) from the BS. The control link may comprise one or more serving cell when the SN MT (i.e. the MT part) is in an RRC_CONNECTED state.

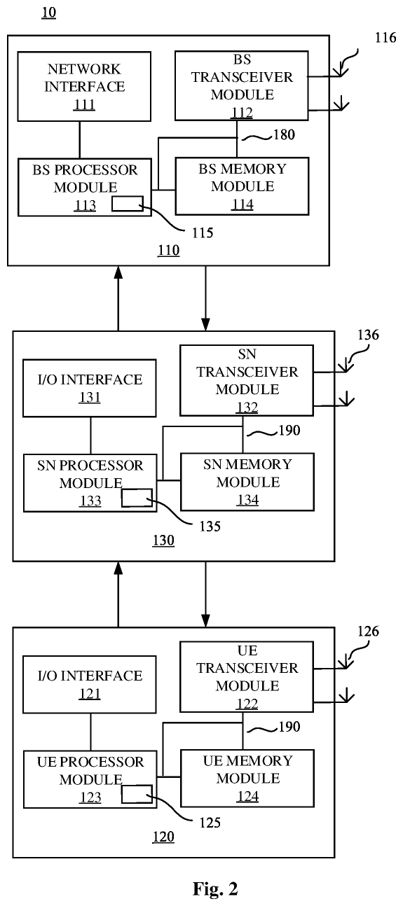

FIG. 2 illustrates a block diagram of an exemplary wireless communication system 10, in accordance with some embodiments of this disclosure. The system 10 may perform the various methods/steps disclosed in this disclosure. The system 10 may include components and elements configured to support operating features that need not be described in detail herein.

The system 10 may include a base station (BS) 110 and a user equipment (UE) 120. The BS 110 includes a BS transceiver or transceiver module 112, a BS antenna system 116, a BS memory or memory module 114, a BS processor or processor module 113, and a network interface 111. The components of BS 110 may be electrically coupled and in communication with one another as necessary via a data communication bus 180. Likewise, the UE 120 includes a UE transceiver or transceiver module 122, a UE antenna system 126, a UE memory or memory module 124, a UE processor or processor module 123, and an I/O interface 121. The components of the UE 120 may be electrically coupled and in communication with one another as necessary via a date communication bus 190. The SN 130, connected between the BS and the UE, includes an SN transceiver or transceiver module 132, an SN antenna system 136, an SN memory or memory module 134, an SN processor or processor module 133, and a network interface 131. The components of SN 130 may be electrically coupled and in communication with one another as necessary via a data communication bus 190. The BS 110 communicates with the UE 120 via the SN 130 and communication channels therebetween, which can be any wireless channel or other medium known in the art suitable for transmission of data as described herein.

As would be understood by persons of ordinary skill in the art, the system 10 may further include any number of modules other than the modules shown in FIG. 2. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

The processor modules 113, 123, 133 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 113, 123, 133, respectively, or in any practical combination thereof. The memory modules 114, 124, 134 may be realized as RAM memory, flash memory, EEPROM memory, registers, ROM memory, EPROM memory, a hard disk, a removable disk, a CD-ROM, or any other form of storage medium known in the art. In this regard, the memory modules 114, 124, 134 may be coupled to the processor modules 113, 123, 133, respectively, such that the processors modules 113, 123, 133 can read information from, and write information to, memory modules 114, 124, 134, respectively. The memory modules 114, 124, 134 may also be integrated into their respective processor modules 113, 123, 133. In some embodiments, the memory modules 114, 124, 134 may each include a cache memory for storing temporary variables or other intermediate information during execution of instructions to be performed by processor modules 113, 123, 133, respectively. The memory modules 114, 124, 134 may also each include non-volatile memory for storing instructions to be performed by the processor modules 113, 123, 133, respectively.

When a mobile device is in an RRC_CONNECTED state, the mobile device may perform Radio Link Monitoring (RLM) in an active BWP (bandwidth part) based on reference signals (RS) and signal quality thresholds configured by the BS. The RS can be an SSB (Synchronization Signal Block) or a CSI (Channel State Information)-RS in NR (New Radio). A mobile device can be configured for each DL (downlink) BWP of a serving cell with a set of RSs for RLM via an RRC (Radio Resource Control) message. If a mobile device is configured with multiple DL BWPs for a serving cell, the mobile device performs RLM using the RS for RLM configured for the active DL BWP. If an RS for RLM are not provided for the active DL BWP, the mobile device may use the RS(s) provided for the active TCI state for PDCCH (Physical Downlink Control Channel) receptions in CORESETs on the active DL BWP.

The mobile device is not required to monitor the downlink radio link quality in DL BWPs other than the active DL BWP. The physical layer in the mobile device assesses, once per indication period, the radio link quality as compared to thresholds configured by an RRC message. The thresholds may include Qout and Qin. The physical layer in the mobile device indicates an out-of-sync status to higher layers when the radio link quality is worse than the threshold Qout for all RS in the set of RSs for RLM. When the radio link quality is better than the threshold Qin for any RS in the set of RSs for RLM, the physical layer in the mobile device indicates an in-sync status to the higher layers.

The mobile device may declare Radio Link Failure (RLF) when one of the following criteria are met: expiry of a radio problem timer started after indication of radio problems from the physical layer. In NR, upon receiving N310 consecutive out-of-sync indications from a physical layer, the mobile device starts a radio problem timer (T310). When timer T310 is running, upon receiving N311 consecutive in-sync indication from the physical layer, the mobile device stops timer T310. Upon N310 counts are reached, the mobile device declares RLF. The value of N310, N311, T310 may be configured by a BS to the mobile device via an RRC message with the IE (Information element) RLF-TimersAndConstants. N310 may define the maximum number of consecutive “out-of-sync” indications received from lower layers for the PCell. N311 may define maximum number of consecutive “in-sync” indications received from lower layers for the PCell.

When RLF is declared, the mobile device may select a suitable cell and then initiate an RRC re-establishment procedure. The mobile device may enter an RRC_IDLE state if a suitable cell was not found within a certain time after the RLF was declared.

In this disclosure, the RS for RLM may also mean the RS with purpose of RLF detection or cell failure detection. The RS for BFD may also mean the RS with purpose for beam failure detection.

For beam failure detection (BFD), the BS configures the mobile device with beam failure detection reference signals (such as SSB or CSI-RS). The mobile device may declare a beam failure status when a number of beam failure instance indications from the physical layer reaches a configured threshold before a configured timer expires.

After a beam failure is detected on the PCell, the mobile device may trigger beam failure recovery by initiating a Random Access (RACH) procedure on the serving cell. The mobile device may include an indication of a beam failure on the PCell in a BFR MAC CE (Medium Access Control Control element) if the RACH procedure involves contention-based random access procedure.

On the other hand, after beam failure is detected on an SCell, the mobile device may trigger a beam failure recovery by initiating a transmission of a BFR MAC CE for this SCell. The mobile device may select a suitable beam for this SCell (if available) and indicate the identity of the beam along with the information about the beam failure in the BFR MAC CE.

For a smart node (SN), including network controlled repeaters (NCR), RF repeaters, and IAB devices, the beams used for the backhaul link and the control link may be different. Taking NCR as an example, the backhaul link and the control link may be in same carrier frequency. The BS configures the beam for backhaul link by indicating one TCI-state list for PDCCH (Physical Downlink Control Channel) reception in the control link. The beam corresponding to the indicated TCI-state is used in the backhaul link. But the beam used in backhaul link is not necessary activated or used in the control link.

Further, in later development, the frequency bandwidth of the backhaul link may be larger than the control link. The frequency bandwidth of backhaul link may be not located in same frequency with the control link.

Therefore, the radio link monitoring and beam failure detection for the backhaul link need to be improved.

According to some embodiments of this disclosure, a BS may configure a radio link monitor (RLM) or beam failure detection (BFD) configuration for a backhaul link of an SN. The configuration may be configured by transmitting an RRC message to the SN's MT (mobile termination) part, and the SN MT part receives the RRC message to be configured. The SN may apply the configuration for the backhaul link's radio link monitoring or beam failure detection.

The RLM or BFD for a backhaul link may be performed by the SN MT part or SN forwarding part. The RLM or BFD configuration may include configuration of a reference signal (RS) that is used for RLM or BFD for the backhaul link. The RS may be associated with a resource set, such as a set of SSB or a set of CSI-RS. The RS may belong to the resource set, but the RS can be one of the reference signals in the resource set.

The RLM or BFD configuration for the backhaul link may be associated with a DL BWP of the SN MT. The SN may apply the RLM or BFD configuration for the backhaul link when the specific DL BWP is activated. The SN may apply another RLM or BFD configuration for another DL BWP.

Alternatively, the RLM or BFD configuration for backhaul link may be not associated with any specific DL BWP of the SN MT. Therefore, the SN may apply the RLM or BFD configuration when any DL BWP is activated.

According to some embodiments of this disclosure, the BS may configure more than one backhaul links associated with a same control link. Each of the backhaul link may be identified by a backhaul link identifier or by the reference information of the backhaul link. The RS may be applied for RLM or BFD for the associated backhaul link.

The BS may configure multiple RSs for the RLM or BFD for the backhaul link, such that each of which is located at a different location in a frequency domain. The BS may configure multiple RSs for RLM or BFD for the backhaul link(s). In such way, each of which is associated with a backhaul link. The RS that is part of the RLM or BFD configuration for the backhaul link may be located within the active BWP of the SN MT, located out of the active BWP of the SN MT, or located out of the carrier frequency of the serving cell of the SN MT.

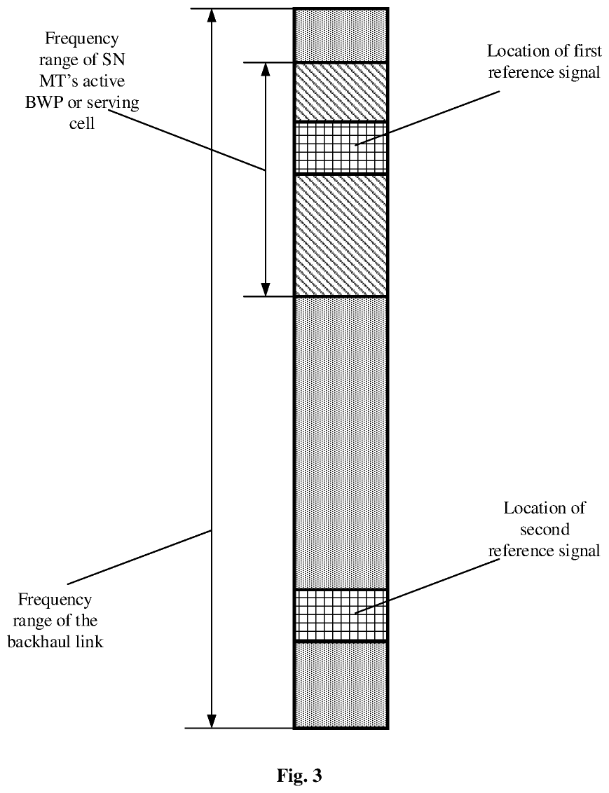

In an example as shown in FIG. 3, the BS may configure two RSs used for RLM or BFD for the backhaul link. The first RS can be located within the frequency range of a SN MT's active BWP or serving cell. The second RS can be located outside of the frequency range of the SN MT's active BWP or serving cell. The first RS and second RS may be associated with one backhaul link respectively. The first RS and second RS may be part of an SSB or CSI-RS configuration.

According to some embodiments of this disclosure, the BS may configure the RS for RLM or BFD for a backhaul link according to one of following options:

Option 1: The BS may configure RLM or BFD configurations for a backhaul link. In a NR system, the configuration may be an IE of RadioLinkMonitoringConfig. This IE may include at least a RS for RLM, a RS for BFD, or a RS for both RLM and BFD.

The BS may configure more than one RLM or BFD configurations, each of which is associated with a respective backhaul link. An RLM or BFD configuration for the backhaul link may be associated with a downlink BWP configured for the SN MT. The SN may apply the RLM or BFD configuration configured for a current active BWP in order to perform RLM or BFD for the backhaul link. Alternatively, the RLM or BFD configuration may be configured not associated to any specific downlink BWP of the SN MT. The SN may apply the configuration when SN MT works in any BWP.

An RLM or BFD configuration may be associated with a backhaul link respectively. The BS may configure the RLM or BFD configuration by including an identifier of the associated backhaul link. The RLM or BFD configuration may be applied for the associated backhaul link.

Alternatively or additionally, an RLM or BFD configuration may be associated with a resource set configuration respectively, such as an SSB configuration or a CSI-RS configuration. The BS may configure the RLM or BFD configuration by including the information of the resource set. The information of the resource set may be the frequency information of the resource set or an identifier of the resource set.

Below is an example IE structure to implement some embodiments of this disclosure:

| | |
|---|---|
| RadioLinkMonitoringConfig-backhaul::= | SEQUENCE { |
| failureDetectionResourcesToAddModList | //this is a list of RS for RLM or BFD |

<skipped part>

| | |
|---|---|
| backhaulLink-Information | // this is the associated backhaul link |

information

| | |
|---|---|
| resourceSet-Information | // this is the associated resource set information |

}

In this example, two new IEs of the information of a backhaul link and resource set are added to IE RadioLinkMonitoringConfig, which is defined in a current specification. It should be noted that these two new IEs are optionally presented and may not be presented at same time.

To associate an RLM or BFD configuration with a DL BWP, the RLM or BFD configuration for the backhaul link may be added to the IE for DL BWP configuration. An example is provided as follows.

| | |
|---|---|
| BWP-DownlinkDedicated ::= | SEQUENCE { |

......

| | |
|---|---|
| radioLinkMonitoringConfig | // this is for RLM or BFD for control link |
| radioLinkMonitoringConfig-backhaul | // this is a RLM or BFD configuration for a |

backhaul link
......
}

To associate an RLM or BFD configuration with a serving cell, rather than being associated with any DL BWPs, the RLM or BFD configuration for the backhaul link may be added to IE ServingCellConfig, which is for serving cell configuration. An example is provided as follows.

| | |
|---|---|
| ServingCellConfig ::= | SEQUENCE { |
| downlinkBWP-ToAddModList | // this is configured DL BWPs |
| radiolinkMonitoringConfig-backhaul | // this is a RLM or BFD configuration for a |

backhaul link
......
}

Option 2: A BS may configure a list of RSs for RLM or BFD for the backhaul link in the RLM configuration for the SN MT. In NR, the list of the RS for RLM or BFD for a backhaul link may be configured by including an IE of failureDetectionResources-ToAddModList or a beam failure in the IE RadioLinkMonitoringConfig, which is configured for a downlink BWP of the SN MT. The RSs for RLM or BFD for the backhaul link may be associated with a resource set. The association may be indicated by including the frequency information of the resource set or by including the identifier of the resource set. The RS may be associated with a backhaul link, which is identified with the identifier or frequency information of the backhaul. An example IE is provided as follows.

| | |
|---|---|
| RadioLinkMonitoringConfig::= | SEQUENCE { |
| failureDetectionResourcesToAddModList | //this is a list of RS for control link |
| failureDetectionResourcesToAddModList-backhaulLink | // this is a list of RS for the |

backhaul link

| | |
|---|---|
| backhaulLink-Information | // this is the associated backhaul link information |
| resourceSet-Information | // this is the resource set associated to backhaul link |

......
}

In this example, the new IE: failureDetectionResourcesToAddModList-backhaulLink, backhaulLink-Information, and resourceSet-Information can be added to existing IE RadioLinkMonitoringConfig. These new IEs cab be used to configure the RS for RLM or BFD for a backhaul link, associated backhaul link information, and associated resource set information.

Option 3: A BS may configure an RS for RLM or BFD for a backhaul link in a list of RSs included in an RLM configuration. In NR, the BS may configure the RS for RLM or BFD for a backhaul link by including the configuration of the RS in IE failureDetectionResources-ToAddModList or a beam failure detection set. The BS may indicate that the purpose of the RS is for RLM for the backhaul link, for BFD for the backhaul link, or for both RLM and BFD for the backhaul link.

The RSs for RLM or BFD for the backhaul link may be associated with a resource set. The association may be indicated by including the frequency information of the resource set or by including the identifier of the resource set. The RS may be associated with a backhaul link, which can be identified with the identifier or frequency information of the backhaul. An example IE is provided as follows.

```
RadioLinkMonitoringConfig::= SEQUENCE {
  failureDetectionResourcesToAddModList
SEQUENCE(SIZE(1..maxNrofFailureDetectionResources)) OF RadioLinkMonitoringRS
  ......
}
```

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, rlf, both}, |
| detectionResource | CHOICE { |
| ssb-Index | SSB-Index, |
| csi-RS-Index | NZP-CSI-RS-ResourceId |

},

| | |
|---|---|
| purpose-for-backHaullink | ENUMAERATED {true, false} |
| backhaulLink-Information | // this is the associated backhaul link information |
| resourceSet-Information | // this is the resource set associated to backhaul link |

......
}

In this example, the RS for RLM or BFD for a backhaul link can be configured by an IE RadioLinkMonitoringRS. The IE RadioLinkMonitoringRS is an element of the list of RSs for RLM or BFD in an existing specification. The RS for backhaul and the RS for control may be configured in the same list. In the configuration of a specific RS, a new IE RadioLinkMonitoringRS can be used to indicate whether the RS is used for backhaul link and to indicate the associated backhaul link information and the associated resource set information.

Option 4: A BS may configure an RS for RLM or BFD for a backhaul link in an implicit way. In this option, the BS does not configure RS for RLM or BFD for backhaul link explicitly in an RRC message. The BS may rather configure the DL beam for a backhaul link by indicating a TCI-state, which is selected from a list of TCI-states configured for PDCCH reception in the control link. In this case, the RS associated to the TCI-state may be applied for RLM or BFD for the backhaul link. When the BS configures a DL beam for a backhaul link, the SN may perform RLM or BFD on the corresponding RS of the DL beam.

According to some embodiments of this disclosure, the BS may further configure other configuration for RLM or BFD for the backhaul link.

For example, the BS may configure the signal quality threshold for the RLM or BFD for a backhaul link. This signal quality threshold for RLM or BFD for the backhaul link may be a different configuration from that for RLM or BFD for a control link by, for example, having a different threshold level or mechanism. In NR, the signal quality threshold may be the BLER threshold pair index for in-sync and out-of-sync indication generation. In NR, this signal quality threshold for RLM may be the IE rlmInSyncOutOfSyncThreshold.

As an example, the BS may further configure a beam failure instance maximum count for a backhaul link. This beam failure instance maximum count may be a different configuration from that for a control link. This beam failure instance maximum count determines after how many beam failure events the SN triggers beam failure recovery.

As an example, the BS may configure a beam failure detection timer for a backhaul link. This beam failure detection timer may be a different configuration from that for a control link. The timer may be used to deal with beam failure detection to, for example, to time a period for counting a number of beam failure. The BS may configure timers and parameters for RLF for a backhaul link. In NR, the timers and parameters may include at least one of N310, N311, or T310. The timers and parameters may be a different configuration from that for a control link to have a different threshold or different trigger condition.

As an example, the SN may apply these configurations for RLM or BFD for the backhaul link once the configuration is set up by the BS.

According to some embodiments of this disclosure, the BS may further configure beam failure recovery (BFR) configuration for the backhaul link.

For example, the BS may configure a BFR configuration for BFR for a backhaul link. As an example, the BFR configuration may include at least one of: a list of RSs, which identifies the candidate beams for recovery and the associated RACH parameters, a timer for beam failure recovery, an L1-RSRP threshold used for determining whether a candidate beam may be used by the SN to attempt contention free random access (RA) to recover from the beam failure, a configuration of random access parameters for BFR, a search space to use for BFR RA, an indication that whether the SN is configured to send BFR MAC CE for the backhaul link.

As an example, the BFR configuration may be associated with an uplink BWP configured for a SN MT. Alternatively, the BFR configuration may be not associated to any specific BWP configured for the SN MT, but instead being shared by multiple BWPs configured for the SN MT.

As an example, the BFR configuration may be associated with a RS for BFD for a backhaul link. In this case, the SN may perform BFR according to the BFR configuration when a beam failure occurs for the RS. As an example, the BFR configuration may be associated with a backhaul link. In this case, the SN may perform BFR for the backhaul link with the associated BFR configuration.

According to some embodiments of this disclosure, the SN may handle the RLF according to some of the following manners. For example, the SN may perform RLM on the RSs configured for RLM for a backhaul link. The SN may perform RLM for the backhaul link according to the RLM configuration for the backhaul link, which is configured by the BS. The RLM may be performed by the SN MT part or by the SN forwarding part.

As an example, the physical layer of the SN may indicate out-of-sync indication to higher layers of the SN, when one or more conditions are met by at least one of: all RS configured for RLM for a backhaul link, all RS configured for RLM for a backhaul link and located in the same frequency location, or all RS configured for RLM for a backhaul link and belong to a same resource set. The one or more conditions may include the radio link quality of the RS is worse than a threshold Qout.

When a RS meets a condition, the physical layer in the SN may indicate an in-sync indication to the SN's higher layers. The RS may be one of: any RS configured for RLM for a backhaul link, any RS configured for RLM for a backhaul link and located in a same frequency location, or any RS configured for RLM for a backhaul link and belong to a same resource set. The condition may be the radio link quality of the RS is better than the threshold Qin.

As an example, when receiving N310 number of consecutive out-of-sync indications from the physical layer for a backhaul link, the SN may start a radio problem timer (such as timer T310) for RLM for the backhaul link. When the timer expires, the SN may declare RLF for the backhaul link. The SN may start more than one radio problem timers, each of which is associated with a backhaul link.

When an RLF of the backhaul link is detected, the SN may act according to at least one of the following manners.

If a backhaul link's RLF is declared but a control link's RLF is not declared, the SN may transmit an RRC message or a MAC CE via the SN MT's serving cell to the BS. The RRC message or MAC CE can be used to indicate that an RLF occurs on the backhaul link. The MAC CE may be a MAC CE with a dedicated MAC CE type for identifying the RLF of the backhaul link. The RRC message may indicate a failure type to represent the backhaul radio link failure.

If a backhaul link's RLF and control link's RLF are both declared, the SN may perform an RRC re-establishment procedure to reestablish the RRC connection. The RRC re-establishment procedure may include at least one of selection of a suitable cell and transmit an RRC re-establishment message to the BS.

If control link's RLF is declared but backhaul link's RLF is not declared, the SN MT may perform an RRC re-establishment procedure to reestablish the RRC connection. The RRC re-establishment procedure may include at least one of selection of a suitable cell and transmit an RRC re-establishment message to the BS. In addition, the SN may stop forwarding TBs in the SN forwarding part.

The MAC CE or the RRC message may include information of a resource set associated with the RLF. The RS for RLM for the backhaul link belongs to the resource set. The information of the resource set may be the frequency information of the resource set or an identifier of the resource set.

Alternatively or additionally, the MAC CE or the RRC message may include information of the backhaul link with the RLF. The information of the backhaul link may include at least one of: the frequency information of the backhaul link or the identifier of the backhaul link.

According to some embodiments of this disclosure, the SN may handle beam failure according to some of the following manners. For example, the SN may perform BFD on the RSs configured for the BFD for a backhaul link. The BFD may be performed by the SN MT part or by the SN forwarding part. The SN may perform the BFD for the backhaul link according to the BFD configuration for the backhaul link, which is configured by the BS.

When beam failure is detected on the backhaul link, the SN may transmit a MAC CE or an RRC message on a serving cell of the SN MT. The MAC CE or the RRC message may indicate that a beam failure is detected on backhaul link. As an example, the MAC CE or the RRC message may indicate information of the RS that is configured for BFD for the backhaul link. The information of the RS configured for the BFD for the backhaul may include at least one of following: an index of the RS, the resource set information to which the RS belongs, or the frequency information of the RS.

As an example, the MAC CE or the RRC message may include information of a candidate RS for establish another beam connection. The candidate RS may be associated with the RS configured for BFD for the backhaul link or may be associated with the backhaul link. As an example, the MAC CE or the RRC message may indicate backhaul link information. The backhaul link information may include at least one of: frequency information of the backhaul or an identifier of the backhaul link.

As an example, when a beam failure is detected on the backhaul link and a beam failure is also detected on the control link, the SN MT may initiate a RACH procedure according to a BFR configuration. The BFR configuration may be associated with the control link or may be associated with the backhaul link. During the RACH procedure, the MAC CE or RRC message may be transmitted to BS.

According to some embodiments of this disclosure, the SN MT may indicate to the BS whether at least one of following capabilities is supported by the SN MT or SN forwarding part to support the RLM or BFD disclosed in this disclosure. Therefore, the BS can understand the capability of the specific UE.

The capabilities that may be reported include at least one of: whether the SN supports RLM for a backhaul link; whether the SN supports BFD for a backhaul link; whether the SN supports RLM for a backhaul link out of the SN MT's active BWP; whether the SN supports BFD for a backhaul link out of the SN MT's active BWP; whether the SN supports RLM for a backhaul link out of a carrier frequency of the SN MT's serving cell; and/or whether the SN supports BFD for a backhaul link out of a carrier frequency of the SN MT's serving cell.

With the disclosure above, the BS can configure an RLM or BFD configuration for a backhaul link. The BS can configure RLM or BFD configuration for more than one backhaul links that are associated with a serving cell of a SN MT. The RLM or BFD configuration for a backhaul link can be DL BWP specific. The BFR configuration for a backhaul link can also be different from that for the control link.

Channel state information (CSI) reporting is used to report downlink channel state information to a BS. The CSI configuration for a UE include CSI resource configuration and CSI report configuration. The CSI reporting configuration includes a CSI resource configuration, which indicates the CSI resources used for CSI measurement and reporting.

According to some embodiments of this disclosure, a BS may configure CSI resource configuration or CSI reporting configuration that associated with a backhaul link. In NR, the CSI resource configuration for a backhaul link may be an IE CSI-ResourcConfig. As an example, the CSI resource configuration for a backhaul link may include the identifier of the backhaul link or the frequency information of the backhaul link. As an example, the CSI resource configuration for a backhaul link may or may not be associated with any downlink BWP of SN MT.

In NR, the CSI reporting configuration for a backhaul link may be an IE CSI-ReportConfig. As an example, The CSI reporting configuration may include a backhaul link identifier. The backhaul link identifier may be used to indicate in which backhaul link the CSI reporting configuration can be found. The CSI measurement and reporting for a backhaul link may be performed by an SN MT part or an SN forwarding part.

According to some embodiments of this disclosure, the SN or BS may activate a semi-static CSI reporting on a PUCCH. A MAC CE can be used to activate the semi-static CSI reporting on PUCCH. Here, a MAC CE may be defined to activate semi-static CSI reporting for a backhaul link. The defined MAC CE may include information that indicate the MAC CE is to activate semi-persistent CSI report configuration for a backhaul link.

As an example, the MAC CE may include a backhaul link identifier. The backhaul link identifier may be used to indicate for which backhaul link the MAC CE applies. The MAC CE may include an activation/deactivation status indicator of the semi-persistent CSI report configuration. The MAC CE can be transmitted from a BS to a SN MT. The SN may activate or deactivate the semi-persistent CSI report configuration according to the MAC CE.

As an example, the SN may indicate to the BS whether it supports at least one of following capabilities: whether the SN supports CSI reporting for a backhaul link; whether the SN supports CSI reporting for a backhaul link that is located out of the SN MT's active BWP; and/or whether the SN supports CSI reporting for a backhaul link that is located out of carrier frequency of the SN MT's serving cell.

The BS therefore can configure the CSI resource and CSI reporting configuration separately for a backhaul link. Then, the BS can configure CSI resource for the backhaul link differently from that for control link. The BS can configure CSI reporting periodicity differently from that for control link. For example, the BS can configure a smaller periodicity for the backhaul link.

For uplink channel state estimation purposes, a UE may be configured to transmit SRS (sounding reference signal), which the BS may use to estimate the uplink channel state and use the estimation in link adaptation.

According to some embodiments of this disclosure, a BS may configure an SRS configuration for a backhaul link.

The SRS configuration for a backhaul link may be transmitted from a BS to an SN MT via an RRC message. The SN may perform SRS transmission according to the SRS configuration for a backhaul link. The SRS transmission for the backhaul link may be performed by the SN MT part or the SN forwarding part. The SRS configuration for the backhaul link may be associated with a UL (uplink) BWP configured for the SN MT. In this case, the SRS configuration for the backhaul link may be applied when the associated UL BWP is activated.

Alternatively, the SRS configuration for backhaul link may be not associated with any specific UL BWP configured for the SN MT. In this case, the SRS configuration for backhaul link may be applied when any UL BWP of the SN MT is activated. All the UL BWP may share the same SRS configuration.

As an example, the SRS configuration may be configured in association with a backhaul link. The association may be implemented by including a backhaul link identifier or frequency information of the backhaul link. Additionally, the BS may configure an SRS configuration for more than one backhaul links. These backhaul links may be associated with one control link or one serving cell of the SN MT.

As an example, the SRS configuration for a backhaul link may include a set of SRS configurations that are dedicated for a backhaul link. In NR, the configuration can be indicated by IE SRS-Config. The backhaul link information may be added to IE SRS-Config. In this case, the SRS configuration may be associated with a UL BWP of the SN MT or may be associated with none of any specific UL BWP of the SN MT.

As an example, the SRS configuration for a backhaul link may include an SRS resource set list for a backhaul link of a SN MT. The SRS resource set list may be dedicated for the backhaul link. In NR, the SRS resource set list may include a list of SRS resource set. In this case, the SRS resource set list for the backhaul link may be associated with a UL BWP of the SN MT.

As an example, the SRS configuration for a backhaul link may include an SRS resource set for a backhaul link. The SRS resource set may include a set of SRS resources. In NR, the SRS resource set may include usage information. The usage information may be used to indicate the SRS resource set is used for a backhaul link. In this case, the SRS resource set for a backhaul link may be associated with a UL BWP of SN MT.

As an example, the SRS configuration for a backhaul link may include an SRS resource for a backhaul link. The SRS resource may include usage information. The usage information may be used to indicated the SRS resource is used for a backhaul link. In this case, the SRS resource for backhaul link may be associated with a UL BWP of SN MT.

As an example, SRS resource for a backhaul link may be periodic, semi-persistent, or aperiodic. To activate a semi-persistent SRS resource for a backhaul link, a MAC CE may be transmitted from a BS to a SN. The MAC CE can be transmitted from a BS to an SN MT. The SN MT may activate or deactivate the semi-persistent SRS resource according to the MAC CE. The MAC CE may include information that indicate the MAC CE is to activate a semi-persistent SRS resource for a backhaul link.

In the MAC CE as an example, a backhaul link identifier may be included. The backhaul link identifier may be used to indicate the backhaul link to which the SRS resource indicated in the MAC CE belongs. The backhaul link identifier may be used to indicate the backhaul link for which the SRS resource indicated in the MAC CE is activated.

As an example, the SN may indicate to the BS whether it support at least one of following capabilities: SRS transmission for backhaul link and/or SRS configuration for backhaul link.

With the disclosure above, the BS can configure SRS configuration dedicated for a backhaul link. The BS can provide a different set of SRS configuration from that for control link. The BS can take the characteristics of backhaul link into account when configure an SRS configuration for a backhaul link. Further, the method provided above enables an SRS configuration for multiple backhaul link.

To enable a more flexible management of a backhaul link according to embodiments of this disclosure, the BS may transmit configuration(s) of more than one backhaul links to a SN MT. The configuration of a backhaul link may include at least one of following: an identifier of a backhaul link; frequency information of a backhaul link, which may the frequency location and bandwidth of a backhaul link; a resource set configuration for a backhaul link, where the resource set may be a set of reference signal (such as an SSB or CSI-RS); an RLM configuration for a backhaul link; an BFD configuration for the backhaul; an SRS configuration for a backhaul link; or a CSI report configuration a the backhaul link.

Before the BS configure the SN, the SN MT may indicate one or more SN forwarding frequency information to BS. An SN forwarding frequency information may include at least one of following: the size of a forwarding frequency, or the location or start point of a forwarding frequency. The SN MT may receive the RRC message from the BS and applies the configuration for the said backhaul link.

With the disclosure above, the BS can manage a SN forwarding frequency that is wider than SN MT's serving cell's carrier frequency. The SN can also define a set of backhaul links based on the SN forwarding frequency. For each backhaul link, a separate RLM, BFD, SRS and CSI reporting may be configured.

According to some embodiments this disclosure, wireless communication methods are disclosed, these methods including: establishing one or more backhaul links between a wireless communication node and a base station (BS); and receiving, by the wireless communication node, first configuration information for performing radio link monitoring (RLM) or beam failure detection (BFD) for the one or more backhaul links.

Optionally for some embodiments of this disclosure, the wireless communication method may further include performing the RLM or the BFD by a MT (mobile termination) part or a forwarding part of the wireless communication node.

Optionally for some embodiments of this disclosure, receiving first configuration information for performing RLM or BFD comprises receiving the first configuration information to configure a first reference signal used for the RLM or BFD for the one or more backhaul links.

Optionally for some embodiments of this disclosure, the first reference signal is located out of an active bandwidth part (BWP) of a MT part of the wireless communication node.

Optionally for some embodiments of this disclosure, the first reference signal is located out of a carrier frequency of one or more serving cells of a MT part of the wireless communication node.

Optionally for some embodiments of this disclosure, receiving the first configuration information for the RLM or BFD further comprises establishing a second reference signal for the RLM or BFD, wherein the first reference and the second reference signals are associated with different backhaul links of the one or more backhaul links.

Optionally for some embodiments of this disclosure, the first reference signal and the second reference signal are located at different frequency domains.

Optionally for some embodiments of this disclosure, the one or more backhaul links are associated with different reference signals.

Optionally for some embodiments of this disclosure, the first configuration information includes at least one of: a reference signal list for the RLM or BFD, information associated with the one or more backhaul links, or resource set information associated with the one or more backhaul links.

Optionally for some embodiments of this disclosure, the first configuration information includes an TCI (Transmission Configuration Indicator) state and a reference signal associated with the TCI-state is used for the RLM or BFD.

Optionally for some embodiments of this disclosure, the first configuration information includes at least one of: a signal quality threshold for the RLM or BFD of the one or more backhaul links; a threshold number of beam failure instances for the one or more backhaul links that would trigger a beam recovery process; a configuration of a beam failure detection timer for the one or more backhaul links; one or more parameters for a radio link failure; or a timer configuration for a radio link failure.

Optionally for some embodiments of this disclosure, the signal quality threshold for the RLM or BFD of the one or more backhaul links is different from a signal quality threshold for a control link between the wireless communication node and the BS.

Optionally for some embodiments of this disclosure, the threshold number of beam failure instances for the one or more backhaul links is different from that for a control link between the wireless communication node and the BS.

Optionally for some embodiments of this disclosure, the configuration of the beam failure detection timer for the one or more backhaul links is different from that of a beam failure detection timer for a control link between the wireless communication node and the BS.

Optionally for some embodiments of this disclosure, the beam failure detection timer for the one or more backhaul links is different from that of a beam failure detection timer for a control link between the wireless communication node and the BS.

Optionally for some embodiments of this disclosure, the one or more parameters for radio link failure (RLF) for the one or more backhaul links are different from that of a control link between the wireless communication node and the BS.

Optionally for some embodiments of this disclosure, the timer configuration for radio link failure for the one or more backhaul links is different from that of a control link between the wireless communication node and the BS.

Optionally for some embodiments of this disclosure, the methods further include receiving a second configuration information for beam failure recovery (BFR) of the one or more backhaul links.

Optionally for some embodiments of this disclosure, the BFR is associated with a same RS of the BFD, and the wireless communication method further comprises performing the BFR according to the BFD.

Optionally for some embodiments of this disclosure, the methods further include comprising starting one or more timers associated in response to RLF of the one or more backhaul links.

Optionally for some embodiments of this disclosure, the methods further include in response to an occurrence of the RLF of the one or more backhaul links when an RLF of a control link has not been declared, transmitting an RRC message or a MAC CE (Medium Access Control Control element) via a serving cell of a MT part of the wireless communication node to indicate the RLF of the one or more backhaul links.

Optionally for some embodiments of this disclosure, the RRC message indicates a failure type of the RLF or a type of MAC CE corresponds to the failure type of the RLF.

Optionally for some embodiments of this disclosure, the RRC message or the MAC CE includes information of a resource set associated to the RLF.

Optionally for some embodiments of this disclosure, the RRC message or the MAC CE includes information of the one or more backhaul links of the occurrence of the RLF, including at least one of: frequency information of the one or more backhaul links or an identity of the one or more backhaul links.

Optionally for some embodiments of this disclosure, the methods further include, when the BFD declares a beam failure, transmitting a MAC CE or an RRC message on a serving cell of a MT part of the wireless communication node to indicate the occurrence of the beam failure.

Optionally for some embodiments of this disclosure, the MAC CE or the RRC message includes candidate RS(s) the one or more backhaul links may switch to.

Optionally for some embodiments of this disclosure, the RRC message or the MAC CE includes information of the one or more backhaul links of the beam failure, including at least one of: frequency information of the one or more backhaul links or an identity of the one or more backhaul links.

Optionally for some embodiments of this disclosure, the methods further include, when beam failures are detected on the backhaul link and a control link between the BS and the wireless communication node, initiating a RACH procedure according to a beam failure recovery (BFR) configuration.

Optionally for some embodiments of this disclosure, the methods further include informing the BS, by the wireless communication node, of at least one of the following capabilities of the wireless communication node: whether the wireless communication node supports an RLM for the backhaul link; whether the wireless communication node supports a BFD for the backhaul link; whether the wireless communication node supports an RLM for the one or more backhaul links out of the wireless communication node's MT part's active BWP; whether the wireless communication node supports a BFD for the one or more backhaul links out of the wireless communication node's MT part's active BWP; whether the wireless communication node supports an RLM for the one or more backhaul links out of a carrier frequency of the wireless communication node's MT part's serving cell; whether the wireless communication node supports a BFD for the one or more backhaul links out of a carrier frequency of the wireless communication node's MT part's serving cell; whether the wireless communication node supports CSI report for the one or more backhaul links; whether the wireless communication node supports CSI report for the one or more backhaul links out of the wireless communication node's MT part's active BWP; whether the wireless communication node supports CSI report for the one or more backhaul links out of a carrier frequency of the wireless communication node's MT part's serving cell; whether the wireless communication node supports transmission of sounding reference signal (SRS); or whether the wireless communication node supports SRS configuration for the one or more backhaul links.

Optionally for some embodiments of this disclosure, the methods further include receiving channel status information (CSI) configuration information for CSI resources or CSI reporting for the one or more backhaul links.

Optionally for some embodiments of this disclosure, the CSI resource configuration information includes at least one of: an identifier of the one or more backhaul links or a frequency information of the one or more backhaul links.

Optionally for some embodiments of this disclosure, the CSI configuration information includes an identifier of the one or more backhaul links indicating in which backhaul link a CSI resource configuration is located.

Optionally for some embodiments of this disclosure, the methods further include measuring and reporting a channel status of the one or more backhaul links by a MT part or a forwarding part of the wireless communication node.

Optionally for some embodiments of this disclosure, the methods further include transmitting a MAC CE to the BS to activate a semi-static CSI reporting or a semi-persistent SRS resource for the one or more backhaul links.

Optionally for some embodiments of this disclosure, the MAC CE includes at least one of: an indication indicating that the MAC CE is to activate the semi-static CSI reporting; an identifier of the one or more backhaul links; or a status information identifying whether the semi-static CSI reporting function is currently active or not.

Optionally for some embodiments of this disclosure, the methods further include receiving SRS (Sounding Reference Signal) configuration information for SRS configuration of the one or more backhaul links.

Optionally for some embodiments of this disclosure, the methods further include transmitting an SRS by a MT part or a forwarding part of the wireless communication node.

Optionally for some embodiments of this disclosure, the SRS configuration information includes at least one of a backhaul link identifier or frequency information of the one or more backhaul links.

Optionally for some embodiments of this disclosure, the methods further include receiving, by the wireless communication node, second configuration information for the one or more backhaul links, the second configuration information including at least one of:

identifiers of the one or more backhaul links; frequency information of the one or more backhaul links; resource set information of the one or more backhaul links; or RLM, BFD, SRS, or CSI report configuration of the one or more backhaul links.

Optionally for some embodiments of this disclosure, the frequency information of the one or more backhaul links includes frequency location information or bandwidth information of the one or more backhaul links and the resource set information includes a set of reference signals.

Optionally for some embodiments of this disclosure, the methods further include indicating, by the wireless communication node, one or more sets of forwarding frequency information of the wireless communication node to the BS.

Optionally for some embodiments of this disclosure, the one or more sets of forwarding frequency information include at least one of a size of the forwarding frequency, a location of the forward frequency, or a start point of the forwarding frequency.

According to some embodiments this disclosure, wireless communication methods are disclosed, these methods including: establishing one or more backhaul links between a wireless communication node and a base station (BS); and sending, by the BS, first configuration information for the wireless communication node to perform radio link monitoring (RLM) or beam failure detection (BFD) for the one or more backhaul links.

Optionally for some embodiments of this disclosure, the RLM or the BFD is performed by an MT (mobile termination) part or a forwarding part of the wireless communication node.

Optionally for some embodiments of this disclosure, sending the first configuration information comprises sending the first configuration information to configure a first reference signal used for the RLM or BFD for the one or more backhaul links.

Optionally for some embodiments of this disclosure, the first reference signal is located out of an active bandwidth part (BWP) of a MT part of the wireless communication node.

Optionally for some embodiments of this disclosure, the first reference signal is located out of a carrier frequency of one or more serving cells of a MT part of the wireless communication node.

Optionally for some embodiments of this disclosure, sending the first configuration information further comprises establishing a second reference signal for the RLM or BFD, wherein the first reference and the second reference signals are associated with different backhaul links of the one or more backhaul links.

Optionally for some embodiments of this disclosure, the first reference signal and the second reference signal are located at different frequency domains.

Optionally for some embodiments of this disclosure, the one or more backhaul links are associated with different reference signals.

Optionally for some embodiments of this disclosure, the first configuration information includes at least one of: a reference signal list for the RLM or BFD, information associated with the one or more backhaul links, or resource set information associated with the one or more backhaul links.

Optionally for some embodiments of this disclosure, the first configuration information includes an TCI (Transmission Configuration Indicator) state and reference signal associated with the TCI-state is used for the RLM or BFD.

Optionally for some embodiments of this disclosure, the first configuration information includes at least one of: a signal quality threshold for the RLM or BFD of the one or more backhaul links; a threshold number of beam failure instances for the one or more backhaul links that would trigger a beam recovery process; a configuration of a beam failure detection timer for the one or more backhaul links; one or more parameters for a radio link failure; and a timer configuration for a radio link failure.

Optionally for some embodiments of this disclosure, the signal quality threshold for the RLM or BFD of the one or more backhaul links is different from a signal quality threshold for a control link between the wireless communication node and the BS.

Optionally for some embodiments of this disclosure, the threshold number of beam failure instances for the one or more backhaul links is different from that for a control link between the wireless communication node and the BS.

Optionally for some embodiments of this disclosure, the configuration of the beam failure detection timer for the one or more backhaul links is different from that of a beam failure detection timer for a control link between the wireless communication node and the BS.

Optionally for some embodiments of this disclosure, the beam failure detection timer for the one or more backhaul links is different from that of a beam failure detection timer for a control link between the wireless communication node and the BS.

Optionally for some embodiments of this disclosure, the one or more parameters for radio link failure (RLF) for the one or more backhaul links are different from that of a control link between the wireless communication node and the BS.

Optionally for some embodiments of this disclosure, the timer configuration for radio link failure for the one or more backhaul links is different from that of a control link between the wireless communication node and the BS.

Optionally for some embodiments of this disclosure, the methods further include sending a second configuration information for beam failure recovery (BFR) of the one or more backhaul links.

Optionally for some embodiments of this disclosure, the BFR is associated with a same RS of the BFD, and the wireless communication method further comprising perform the BFR according to the BFD.

Optionally for some embodiments of this disclosure, the methods further include configuring the wireless communication node to start one or more timers associated in response to RLF of the one or more backhaul links.

Optionally for some embodiments of this disclosure, the methods further include, in response to an occurrence of the RLF of the one or more backhaul links when an RLF of a control link has not been declared, receiving an RRC message or a MAC CE (Medium Access Control Control element) via a serving cell of a MT part of the wireless communication node to indicate the RLF of the one or more backhaul links.

Optionally for some embodiments of this disclosure, the RRC message indicates a failure type of the RLF or a type of MAC CE corresponds to the failure type of the RLF.

Optionally for some embodiments of this disclosure, the RRC message or the MAC CE includes information of a resource set associated to the RLF.

Optionally for some embodiments of this disclosure, the RRC message or the MAC CE includes information of the one or more backhaul links of the occurrence of the RLF, including at least one of: frequency information of the one or more backhaul links or an identity of the one or more backhaul links.

Optionally for some embodiments of this disclosure, the methods further include, when the BFD declares a beam failure, receiving a MAC CE or an RRC message on a serving cell of a MT part of the wireless communication node to indicate the occurrence of the beam failure.

Optionally for some embodiments of this disclosure, the MAC CE or the RRC message includes candidate RS(s) the one or more backhaul links may switch to.

Optionally for some embodiments of this disclosure, the RRC message or the MAC CE includes information of the one or more backhaul links of the beam failure, including at least one of: frequency information of the one or more backhaul links or an identity of the one or more backhaul links.

Optionally for some embodiments of this disclosure, the methods further include, when beam failures are detected on the one or more backhaul links and a control link between the BS and the wireless communication node, responding to a RACH procedure according to a beam failure recovery (BFR) configuration.

Optionally for some embodiments of this disclosure, the methods further include, receiving information of at least one of the following capabilities of the wireless communication node: whether the wireless communication node supports an RLM for the backhaul link; whether the wireless communication node supports a BFD for the backhaul link; whether the wireless communication node supports an RLM for the one or more backhaul links out of the wireless communication node's MT part's active BWP; whether the wireless communication node supports a BFD for the one or more backhaul links out of the wireless communication node's MT part's active BWP; whether the wireless communication node supports an RLM for the one or more backhaul links out of a carrier frequency of the wireless communication node's MT part's serving cell; whether the wireless communication node supports a BFD for the one or more backhaul links out of a carrier frequency of the wireless communication node's MT part's serving cell; whether the wireless communication node supports CSI report for the one or more backhaul links; whether the wireless communication node supports CSI report for the one or more backhaul links out of the wireless communication node's MT part's active BWP; whether the wireless communication node supports CSI report for the one or more backhaul links out of a carrier frequency of the wireless communication node's MT part's serving cell; whether the wireless communication node supports transmission of sounding reference signal (SRS); or whether the wireless communication node supports SRS configuration for the one or more backhaul links.

Optionally for some embodiments of this disclosure, the methods further include, sending channel status information (CSI) configuration information for CSI resources or CSI reporting for the one or more backhaul links.

Optionally for some embodiments of this disclosure, the CSI resource configuration information includes at least one of: an identifier of the one or more backhaul links or a frequency information of the one or more backhaul links.

Optionally for some embodiments of this disclosure, the CSI configuration information includes an identifier of the one or more backhaul links indicating in which backhaul link a CSI resource configuration is located.

Optionally for some embodiments of this disclosure, the methods further include configuring the wireless communication node to measure and report a channel status of the one or more backhaul links by a MT part or a forwarding part of the wireless communication node.

Optionally for some embodiments of this disclosure, the methods further include receiving a MAC CE by the BS to activate a semi-static CSI reporting or a semi-persistent SRS resource for the one or more backhaul links.

Optionally for some embodiments of this disclosure, the MAC CE includes at least one of: an indication indicating that the MAC CE is to activate the semi-static CSI reporting; an identifier of the one or more backhaul links; or a status information identifying whether the semi-static CSI reporting function is currently active or not.

Optionally for some embodiments of this disclosure, the methods further include sending SRS configuration information for SRS configuration of the one or more backhaul links.

Optionally for some embodiments of this disclosure, the methods further include comprising receiving an SRS from a MT part or a forwarding part of the wireless communication node.

Optionally for some embodiments of this disclosure, the SRS configuration information includes at least one of a backhaul link identifier or frequency information of the one or more backhaul link.

Optionally for some embodiments of this disclosure, the methods further include sending second configuration information for the backhaul links, including at least one of:

identifiers of the one or more backhaul links; frequency information of the one or more backhaul links; resource set information of the one or more backhaul links; or RLM, BFD, SRS, or CSI report configuration of the one or more backhaul links.

Optionally for some embodiments of this disclosure, the frequency information of the one or more backhaul links includes frequency location information or bandwidth information of the one or more backhaul links and the resource set information includes a set of reference signals.

Optionally for some embodiments of this disclosure, the methods further include receiving information of one or more sets of forwarding frequency information of the wireless communication node to the BS.

Optionally for some embodiments of this disclosure, the one or more sets of forwarding frequency information include at least one of a size of the forwarding frequency, a location of the forward frequency, or a start point of the forwarding frequency.

According to some embodiments this disclosure, a wireless communication apparatus is disclosed. The apparatus includes a memory storing one or more programs and one or more processors electrically coupled to the memory and configured to execute the one or more programs to perform any disclosed methods, steps, aspects, and their combinations.

According to some embodiments this disclosure, a non-transitory computer-readable storage medium is disclosed. The medium stores one or more programs, the one or more programs being configured to, when executed by a processor, cause perform any disclosed methods, steps, aspects, and their combinations.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1. A wireless communication method, comprising:
establishing one or more backhaul links between a wireless communication node and a base station (BS);
receiving, by the wireless communication node, first configuration information for performing radio link monitoring (RLM) or beam failure detection (BFD) for the one or more backhaul links, wherein receiving first configuration information for performing RLM or BFD comprises receiving the first configuration information to configure a first reference signal used for the RLM or BFD for the one or more backhaul links; and
performing the RLM or the BFD by a mobile termination (MT) part or a forwarding part of the wireless communication node.

2. (canceled)

3. (canceled)

4. The wireless communication method of claim 1, wherein the first reference signal is located out of an active bandwidth part (BWP) of a MT part of the wireless communication node.

5. The wireless communication method of claim 1, wherein the first reference signal is located out of a carrier frequency of one or more serving cells of a MT part of the wireless communication node.

6. (canceled)

7. (canceled)

8. The wireless communication method of claim 1, wherein the one or more backhaul links are associated with different reference signals.

9. The wireless communication method of claim 1, wherein the first configuration information includes at least one of: a reference signal list for the RLM or BFD, information associated with the one or more backhaul links, or resource set information associated with the one or more backhaul links.

10. (canceled)

11. (canceled)

12. (canceled)

13. The wireless communication method of claim 1, further comprising receiving a second configuration information for beam failure recovery (BFR) of the one or more backhaul links, wherein the BFR is associated with a same RS of the BFD, and the wireless communication method further comprises performing the BFR according to the BFD.

14. (canceled)

15. The wireless communication method of claim 1, further comprising:
starting one or more timers associated in response to RLF of the one or more backhaul links; or
in response to an occurrence of the RLF of the one or more backhaul links when an RLF of a control link has not been declared, transmitting an RRC message or a Medium Access Control Control element (MAC CE) via a serving cell of a MT part of the wireless communication node to indicate the RLF of the one or more backhaul links, wherein the RRC message or the MAC CE includes information of the one or more backhaul links of the occurrence of the RLF, including at least one of: frequency information of the one or more backhaul links or an identity of the one or more backhaul links.

16. (canceled)

17. (canceled)

18. (canceled)

19. (canceled)

20. The wireless communication method of claim 1, further comprising, when the BFD declares a beam failure, transmitting a MAC CE or an RRC message on a serving cell of a MT part of the wireless communication node to indicate the occurrence of the beam failure,
wherein the MAC CE or the RRC message includes candidate RS(s) the one or more backhaul links may switch to; or,
wherein the RRC message or the MAC CE includes information of the one or more backhaul links of the beam failure, including at least one of: frequency information of the one or more backhaul links or an identity of the one or more backhaul links.

21. (canceled)

22. (canceled)

23. (canceled)

24. (canceled)

25. The wireless communication method of claim 1, further comprising receiving channel status information (CSI) configuration information for CSI resources or CSI reporting for the one or more backhaul links,
wherein the CSI resource configuration information includes at least one of: an identifier of the one or more backhaul links or a frequency information of the one or more backhaul links, and the CSI configuration information includes an identifier of the one or more backhaul links indicating in which backhaul link a CSI resource configuration is located.

26. (canceled)

27. (canceled)

28. The wireless communication method of claim 1, further comprising measuring and reporting a channel status of the one or more backhaul links by a MT part or a forwarding part of the wireless communication node.

29. The wireless communication method of claim 1, further comprising transmitting a MAC CE to the BS to activate a semi-static CSI reporting or a semi-persistent SRS resource for the one or more backhaul links, wherein the MAC CE includes at least one of: an indication indicating that the MAC CE is to activate the semi-static CSI reporting; an identifier of the one or more backhaul links; or a status information identifying whether the semi-static CSI reporting function is currently active or not.

30. (canceled)

31. The wireless communication method of claim 1, further comprising receiving Sounding Reference Signal (SRS) configuration information for SRS configuration of the one or more backhaul links,
further comprising transmitting an SRS by a MT part or a forwarding part of the wireless communication node; or,
wherein the SRS configuration information includes at least one of a backhaul link identifier or frequency information of the one or more backhaul links.

32. (canceled)

33. (canceled)

34. The wireless communication method of claim 1, further comprising receiving, by the wireless communication node, second configuration information for the one or more backhaul links, the second configuration information including at least one of:
identifiers of the one or more backhaul links;
frequency information of the one or more backhaul links;
resource set information of the one or more backhaul links; or
RLM, BFD, SRS, or CSI report configuration of the one or more backhaul links.

35. The wireless communication method of claim 34, wherein the frequency information of the one or more backhaul links includes frequency location information or bandwidth information of the one or more backhaul links and the resource set information includes a set of reference signals.

36. The wireless communication method of claim 1, further comprising indicating, by the wireless communication node, one or more sets of forwarding frequency information of the wireless communication node to the BS, wherein the one or more sets of forwarding frequency information include at least one of a size of the forwarding frequency, a location of the forward frequency, or a start point of the forwarding frequency.

37. (canceled)

38. A wireless communication method, comprising:
establishing one or more backhaul links between a wireless communication node and a base station (BS); and
sending, by the BS, first configuration information for the wireless communication node to perform radio link monitoring (RLM) or beam failure detection (BFD) for the one or more backhaul links, wherein sending the first configuration information comprises sending the first configuration information to configure a first reference signal used for the RLM or BFD for the one or more backhaul links, wherein the RLM or the BFD is performed by a mobile termination (MT) part or a forwarding part of the wireless communication node.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. A wireless communication apparatus, comprising a memory storing one or more programs and one or more processors electrically coupled to the memory and configured to execute the one or more programs to perform the method of claim 1.

76. A non-transitory computer-readable storage medium, storing one or more programs, the one or more programs being configured to, when executed by a processor, cause to perform the method of claim 1.

77. A wireless communication apparatus, comprising a memory storing one or more programs and one or more processors electrically coupled to the memory and configured to execute the one or more programs to perform the method of claim 38.

78. A non-transitory computer-readable storage medium, storing one or more programs, the one or more programs being configured to, when executed by a processor, cause to perform the method of claim 38.
